(19) United States
(12) Patent Application Publication
(10) Pub. No.: US 2026/0264121 A1
(43) Pub. Date: Sep. 10, 2026

(54) SUCTION DEVICE AND LASER DEVICE

(71) Applicant: 4JET TECHNOLOGIES GMBH, Alsdorf (DE)

(72) Inventors: Armin KRAUS, Aldenhoven (DE); André LANGE, Aachen (DE); Michael GERGEN, Aachen (DE)

(21) Appl. No.: 19/165,980

(22) PCT Filed: Mar. 18, 2024
(86) PCT No.: PCT/EP2024/057197

§ 371 Date: Sep. 16, 2025

(30) Foreign Application Priority Data
Mar. 19, 2023 (DE) 20 2023 101 363.5

(51) Int. Cl. B08B 15/04; B23K 26/16

(52) U.S. Cl. CPC B08B 15/04; B23K 26/16

(57) ABSTRACT

Disclosed is a suction device comprising: an air guiding device and a flow inlet for generating a suction flow through the air guiding device into the flow inlet. The air guiding device is configured is such that a projection of the air guiding device onto a surface of an imaginary sphere covers at least 30% of the surface. Herein, the projection is in a radial direction from a center point of the imaginary sphere to the surface of the imaginary sphere, wherein the center point of the imaginary sphere is arranged in a center of the flow inlet. A radius of the imaginary sphere is selected to be so large that the imaginary sphere completely encloses the air guiding device. The air guiding device comprises a first opening which, in operation, faces a processing location on a substrate and a second opening through which a laser radiation can be emitted through the air guiding device and through the first opening. Further disclosed is a laser device comprising the suction device and a laser emitting device.

### CROSS-REFERENCE TO RELATED APPLICATIONS

This application is a National Phase patent application and claims priority to and the benefit of International Application Number PCT/EP2024/057197, filed on 18 Mar. 2024, which claims priority to and the benefit of German Patent Application No. 20 2023 101 363 U1, filed 19 Mar. 2023, the entire contents of all of which are incorporated herein by reference.

### TECHNICAL FIELD

The present disclosure relates to the field of suction devices for laser processing.

### BACKGROUND

It is known from practice to suck off process residues (such as, for example, particles or vapors) arising in the laser processing of substrates (for example in a cleaning of a substrate with laser radiation or a removal of a part of the substrate with laser radiation).

### SUMMARY

In any case, known suction devices can effect only inadequate suction under certain conditions, so that process residues can pass into the ambient air in an MW: al undesired manner. For example, the process residues can remain in the laser beam path for longer than desired in a performance-reducing manner, can deposit on the substrate and/or can be deposited on the laser optics, to name just a few examples.

In view of the situation described above, there is a need for a technique which allows improved suction, while one or more of the problems specified above are substantially avoided.

This need may be met by the independent claims. Some advantageous embodiments are specified in the dependent claims.

According to a first aspect of the herein disclosed subject matter, a suction device is provided.

According to an embodiment of the first aspect, a suction device is provided, the suction device comprising: an air guiding device; a flow inlet for generating a suction flow through the air guiding device into the flow inlet; wherein the air guiding device is configured such that a projection of the air guiding device onto a surface of an imaginary sphere covers at least 60% of the surface; wherein the projection is in a radial direction from a center point of the imaginary sphere to a surface of the imaginary sphere; wherein the center point of the imaginary sphere is arranged in a center of the flow inlet; and wherein a radius of the imaginary sphere is selected such that the imaginary sphere completely encloses the air guiding device; wherein the air guiding device further comprises a first opening which, in operation, faces a processing location on a substrate; and wherein the air guiding device further comprises a second opening through which a laser radiation can be emitted through the air guiding device and through the first opening.

According to a second aspect of the herein disclosed subject matter, a laser device is provided.

According to an embodiment of the second aspect, a laser device is provided, the laser device comprising: a laser emitting device for emitting laser radiation to a substrate surface of a substrate and thereby processing the substrate surface in a processing region; a suction device for sucking off process residues arising in the processing of the substrate surface; wherein the suction device is configured according to the first aspect or at least one embodiment of the first aspect.

### DESCRIPTION OF EXEMPLARY EMBODIMENTS

Although certain disadvantages of known technologies are mentioned herein, the claimed subject matter is not intended to be limited to implementations which overcome some or all of the mentioned disadvantages of the known technologies. Furthermore, although certain advantages of the herein disclosed subject matter are mentioned or implied in the present disclosure, the claimed subject matter is not intended to be limited to implementations which have some or all of these advantages.

A suction device according to the first aspect according to an embodiment comprises an air guiding device. Further, the suction device according to an embodiment comprises a flow inlet for generating a suction flow through the air guiding device and into the flow inlet. According to an embodiment, the air guiding device is configured such that a projection of the air guiding device onto a surface of an imaginary sphere covers at least 60% of the surface (of the imaginary sphere). According to a further embodiment, the projection of the air guiding device onto the surface of the imaginary sphere covers at least 75% or at least 85% of the surface. The projection is in an embodiment in a radial direction from a center point of the imaginary sphere to the surface of the imaginary sphere. According to an embodiment, the center point of the imaginary sphere is arranged in a center of the flow inlet. A radius of the imaginary sphere is according to an embodiment selected such that the imaginary sphere completely encloses the air guiding device. According to a further embodiment, the air guiding device further comprises a first opening which, in operation (of the suction device) faces a processing location on a substrate. According to an embodiment, the air guiding device further comprises a second opening through which a laser radiation can be emitted through the air guiding device and through the first opening (during operation of the suction device, the laser radiation is emitted onto the substrate to thereby process the substrate).

A laser device according to the second aspect according to an embodiment comprises a laser emitting device for emitting laser radiation to a substrate surface of a substrate. By emitting the laser radiation onto the substrate surface (i.e. onto a processing region of the substrate surface), according to an embodiment, the substrate surface is processed in the processing region. According to an embodiment, the laser device further comprises a suction device according to embodiments of the herein disclosed subject matter. According to an embodiment, the suction device is configured for sucking off process residues arising in the processing of the substrate surface. Process residues within the meaning of the present disclosure comprise, for example, particles and/or vapors arising in the laser processing of substrates (for example in a cleaning of a substrate with laser radiation or in a removal of a part of the substrate with laser radiation).

At least some of the aspects and embodiments of the herein disclosed subject matter are based on the idea that a suction device for sucking off process residues in a laser processing can be improved by providing an air guiding device which is configured such that, with respect to a flow inlet through which a suction flow is generated, the projection of the air guiding device onto a surface of an imaginary sphere covers at least 30% of the surface of this sphere, wherein the air guiding device comprises at least a first opening and a second opening through which the laser radiation can be emitted through the air guiding device onto the substrate surface to be processed. The herein explained embodiments are suitable for improving or optimizing the sucking off of process residues.

According to embodiments of the first aspect, the suction device is configured for providing the functionality of one or more of the herein disclosed embodiments and/or for providing the functionality as required for one or more of the herein disclosed embodiments, in particular of the embodiments of the first aspect and/or of the second aspect.

According to embodiments of the second aspect, the laser device is configured for providing the functionality of one or more of the herein disclosed embodiments and/or for providing the functionality as required for one or more of the herein disclosed embodiments, in particular of the embodiments of the first aspect and/or of the second aspect.

Exemplary implementations of the herein disclosed subject matter comprise in particular the embodiments described below and combinations of embodiments:

According to an embodiment, the air guiding device comprises a straight beam path for the laser radiation. For example, the straight beam path extends through the second opening and the first opening. According to an embodiment, the beam path is free of solids. According to a further embodiment, a material is arranged in the beam path which is transparent for the laser radiation. According to a further embodiment, the material in the beam path is a solid. For example, according to an embodiment, a window can be arranged in the second opening. It is understood that the window is configured such (for example, a material of the window is selected such) that the window is transparent for the laser radiation used.

According to a further embodiment, the air guiding device comprises a third opening which is arranged between the first opening and the second opening. According to an embodiment, the third opening faces the flow inlet. According to a further embodiment, the third opening defines a flow path from the third opening into the flow inlet, wherein this flow path according to an embodiment extends through the beam path. In other words, the first opening and the second opening define a first direction which extends transversely to the flow path leading from the third opening into the flow inlet.

According to an embodiment, both a flow entering the air guiding device through the first opening and a flow entering the air guiding device through the second opening are deflected in the direction of the flow inlet by the third opening.

According to an embodiment, the suction flow in the flow inlet has a flow direction and the straight beam path (of the laser radiation) forms an angle with the flow direction in the flow inlet which is greater than 30 degrees. For example, this angle is greater than 50 degrees or greater than 70 degrees. According to a further embodiment, this angle is less than 90 degrees. In other words, according to an embodiment, the flow inlet does not extend perpendicularly to the beam path of the laser radiation, but is inclined at an acute angle to the first opening (which, in operation, faces the substrate). For example, the (acute) angle can be 75 degrees.

According to an embodiment, the projection of the air guiding device does not cover a surface portion of the surface of the imaginary sphere, which uncovered surface portion is arranged opposite to the flow inlet. For example, the surface portion of the surface of the imaginary sphere uncovered by the projection of the air guiding device is defined by the third opening.

According to an embodiment, a straight line which is defined by the center point of the imaginary sphere and the flow direction of the suction flow in the flow inlet extends through the uncovered surface portion of the imaginary sphere.

According to an embodiment, the projection of the air guiding device and a projection of the first opening together cover at least 70% of the imaginary sphere. In other words, a projection of all openings of the air guiding device, with the exception of the first opening (which faces the substrate), covers at most 30% of the imaginary sphere, for example at most 20%, at most 10% or at most 5%. According to a further embodiment, the projection of the air guiding device and a projection of the first opening together cover at least 80% or at least 90% of the imaginary sphere.

According to an embodiment, the air guiding device comprises at least two sections (i.e. air guiding sections) which are spatially fixed relative to each other. For example, the openings of the air guiding device (for example the first opening, the second opening and/or the third opening) can be defined by two or more sections of the air guiding device. For example, the air guiding device can be composed of two or more parts. According to an alternative embodiment, the air guiding device can be formed integrally.

According to an embodiment, the radius of the imaginary sphere is a minimum radius with which the imaginary sphere completely encloses the air guiding device.

According to an embodiment, the suction flow through the air guiding device comprises a flow part of which at least one directional component extends along the straight beam path (of the laser radiation) and through the second opening into the air guiding device (i.e. away from a laser source).

According to an embodiment, the air guiding device is mechanically connected to the flow inlet. For example, according to an embodiment, the air guiding device is mechanically connected to the flow inlet such that a movement of the flow inlet effects a corresponding movement of the air guiding device. For example, the air guiding device can be rigidly connected to the flow inlet, e.g. attached to the flow inlet (or a pipe section which forms the flow inlet).

According to an embodiment, the suction device comprises a negative pressure source and a first flow path fluidically connecting the negative pressure source and the flow inlet for generating with the negative pressure source the suction flow into the flow inlet. The first flow path can be formed by a piping, for example. According to an embodiment, the suction device is attached to the piping. According to a further embodiment, the suction device can be formed at least partially by a correspondingly configured end of the piping. According to an embodiment, the flow inlet is formed by the piping.

According to an embodiment, a flow velocity in the flow inlet is at least 15 m/s, for example more than 25 m/s. For example, according to an embodiment, the negative pressure source and/or the first flow path are configured to achieve flow velocities in the flow inlet of more than 15 m/s. According to a further embodiment, a volume flow in the flow inlet is more than 100 m³/h. According to a further embodiment, the negative pressure wave is configured to generate a volume flow >100 m³/h in the flow inlet. According to an embodiment, the volume flow is >150 m³/h.

According to an embodiment, a mean cross-sectional area of the first flow path is greater than 30 cm², for example greater than 38 cm² (corresponding to a circular cross-section of 70 mm diameter).

According to an embodiment, the sum of cross-sectional areas of all openings of the air guiding device (for example a sum of a cross-sectional area of the first opening, a cross-sectional area of the second opening and a cross-sectional area of the third opening) is less than three times a cross-sectional area of the flow inlet. In other words, according to an embodiment, the first opening has a first cross-sectional area, the second opening has a second cross-sectional area, the third opening has a third cross-sectional area and the flow inlet has a fourth cross-sectional area, wherein a sum of the first cross-sectional area, the second cross-sectional area and the third cross-sectional area is less than three times the fourth cross-sectional area. According to a further embodiment, the sum of the cross-sectional areas of the openings (of all openings) of the air guiding device is less than two times the cross-sectional area of the flow inlet.

According to an embodiment, the flow velocity in at least one of the first opening, the second opening and the third opening is greater than 10 m/s. According to a further embodiment, the flow velocity in the second flow path is at least in sections greater than 10 m/s.

According to an embodiment, the cross-sectional area of the flow inlet is between 10 cm² and 30 cm², for example 19 cm². For example, according to an embodiment, the flow inlet is circular with a diameter of 50 mm.

According to an embodiment, the second opening is smaller than the first opening. According to a further embodiment, the first opening is rectangular or approximately rectangular. According to a further embodiment, a short side of the first opening is less than 20 mm.

Both a high flow velocity in the flow inlet as well as an in the sum limited cross-sectional area of the openings of the air guiding device can contribute to an efficient suction.

According to an embodiment, the air guiding device comprises a body and a coating on the body. For example, the coating is formed of a material for which the adhesion of dirt particles is reduced compared to an adhesion of the dirt particles to a material of the body. For example, according to an embodiment, the coating is a non-stick coating. For example, according to an embodiment, the coating comprises polytetrafluoroethylene (PTFE). According to an embodiment, the body is completely coated with the coating.

According to an embodiment, the suction device can be part of a laser device, for example a laser device as defined above with respect to the second aspect.

According to an embodiment, the laser emitting device defines on the substrate surface an irradiation region which can be illuminated by the laser radiation without a relative movement of the laser emitting device, the suction device and the substrate surface relative to each other. For example, according to an embodiment, the laser radiation forms a laser spot on the substrate surface, wherein the irradiation region is defined by the laser spot. Further, according to an embodiment, the irradiation region can be defined, for example, by a scanning region of the laser emitting device, for example when the laser emitting device is configured to move (scan) the laser radiation over the scanning region. Herein, the scanning can be performed as usual without or independent of a relative movement of the laser emitting device to the substrate, for example by one or more galvanometer scanners.

According to an embodiment, the laser device comprises an actuator arrangement, wherein the actuator arrangement is configured for moving the irradiation region and the substrate surface relative to each other. According to an embodiment, the actuator arrangement is configured for moving the laser emitting device and the substrate relative to each other, in particular during the emitting of the laser radiation. A movement of the substrate surface and the irradiation region relative to each other or a movement of the substrate surface and the laser emitting device relative to each other is also referred to herein as a relative movement. For example, the actuator arrangement can be configured for pivoting the laser emitting device relative to the substrate surface, for example for pivoting the laser emitting device about an axis of rotation of the pneumatic tire and/or for traversing the laser emitting device parallel to the axis of rotation of the pneumatic tire. According to a further embodiment, the actuator arrangement is configured for moving the substrate relative to the laser emitting device, for example for rotating a pneumatic tire about its axis of rotation, for example while a position of the laser emitting device is maintained.

According to an embodiment, the laser device comprises a substrate carrier. The substrate carrier is configured according to an embodiment for carrying the substrate during the processing of the substrate surface.

According to an embodiment, the substrate is a vulcanized rubber material. For example, the substrate is a pneumatic tire comprising a vulcanized rubber material. The vulcanized rubber material can contain additives, for example carbon black, in a known manner. According to an embodiment, the substrate carrier is a tire carrier which grips the pneumatic tire in the region of the tire bead.

According to an embodiment, the relative movement of the substrate surface and the irradiation region relative to each other is a circular movement about a tire rotation axis of the pneumatic tire. According to an embodiment, it can be provided that the actuator arrangement is configured for moving the flow inlet radially to the tire rotation axis, for example for positioning the flow inlet in a predetermined position with respect to a surface of the pneumatic tire.

According to an embodiment, the laser device is configured for selectively removing rubber material (for example rubber material of the pneumatic tire). According to an embodiment, the laser device can be configured for selectively removing rubber material to thereby correct (or improve) concentricity properties of a pneumatic tire.

According to an embodiment, the laser device is configured for removing process residues from the tire vulcanization. For example, the laser device can be configured for removing a release agent remaining on a tire inner surface after the tire vulcanization.

According to an embodiment, the center point of the imaginary sphere is less than 20 cm away from the processing region (or the irradiation region). In other words, according to an embodiment, a distance of the center point of the imaginary sphere from the processing region/irradiation region is less than 20 cm. According to an embodiment, the distance between the center point of the imaginary sphere and the processing region/irradiation region is less than 15 cm or, in a further embodiment, less than 10 cm. As explained above, according to an embodiment, the center point of the imaginary sphere is arranged in a center of the flow inlet. Thus, the terms “center point of the imaginary sphere” and “center of the flow inlet” are interchangeable within the scope of the present disclosure. Thus, according to an embodiment, the center point of the imaginary sphere is less than 20 cm away from the processing region/irradiation region.

According to an embodiment, a second flow path is formed between the substrate and the air guiding device. According to an embodiment, the second flow path has at its narrowest location a cross-sectional area whose area is larger than 5% of the area of the surface of the imaginary sphere. According to a further embodiment, the second flow path has at its narrowest location a cross-sectional area whose area is smaller than 15% of the area of the surface of the imaginary sphere. According to a further embodiment, the second flow path has at its narrowest location a cross-sectional area whose area is smaller than two times the cross-sectional area of the flow inlet.

According to an embodiment, the second flow path guides at least a part of the suction flow over a part of the processing region. According to a further embodiment, the second flow path guides at least a part of the suction flow over the irradiation region (i.e. the region which can be illuminated by the laser emitting device without a relative movement of the laser emitting device and the substrate).

According to an embodiment, at least one edge of the first opening or at least one edge of the air guiding device has a radius of curvature which is greater than 0.5 millimeters (mm). According to a further embodiment, the radius of curvature is greater than 1 mm or greater than 5 mm. For example, the edge is formed by two surface parts of the air guiding device extending transversely to each other. Undesired turbulences in the suction flow can be avoided by rounded edges having such a radius of curvature.

According to a further embodiment, an opening edge of the first opening (which faces in the substrate) and/or a surface of the air guiding device which at least partially defines the second flow path extends in a curved surface. In other words, the opening edge and/or the surface of the air guiding device which (in operation of the suction device) faces the substrate are correspondingly curved. The curved surface (which is a surface in the mathematical sense) may herein have a radius of curvature which is greater than 100 millimeters. According to a further embodiment, the curved surface may follow the surface of the substrate. In other words, according to an embodiment, a distance between the curved surface (e.g. a distance between the opening edge or the surface of the air guiding device) and the substrate may be constant or approximately constant.

According to an embodiment, the laser emitting device is configured for pivoting the laser radiation with respect to the substrate surface. For example, the laser emitting device may comprise at least one galvanometer scanner by which the laser radiation is pivotable with respect to the laser emitting device in at least one pivoting plane. In this way, the laser radiation may be moved with respect to the substrate surface without moving the laser emitting device. It is understood that in a general embodiment, both a movement of the laser radiation with respect to the laser emitting device and a movement of the laser emitting device and the substrate relative to each other may occur. For example, for a concentricity correction of a pneumatic tire, it can be provided that the actuator arrangement moves the laser emitting device and the pneumatic tire relative to each other about the axis of rotation of the pneumatic tire and that to this rotational movement a movement of the laser radiation is moved in a plane transverse to a rotation plane of the pneumatic tire, for example by one or more galvanometer scanners as described above.

According to an embodiment, the laser device comprises a control device, wherein the control device is configured for controlling the laser emitting device. For example, the control device can be configured for, based on parameter values representing a desired correction of concentricity properties of a pneumatic tire, processing the pneumatic tire with the laser radiation of the laser device and thereby performing the desired correction.

According to a further embodiment, the laser device comprises a further control device which is configured for controlling the actuator arrangement.

According to an embodiment, the control device and the further control device are formed by a single, common control device. For example, it can be provided that the common control device on the one hand controls a power of the laser radiation and/or the at least one galvanometer scanner and on the other hand controls the actuator arrangement for moving the irradiation region and the pneumatic tire relative to each other.

According to an embodiment, the substrate carrier and the suction device are configured and arranged for defining and/or ensuring a spatial relationship between the substrate and the suction device according to embodiments of the herein disclosed subject matter. According to a further embodiment, the laser device comprises a control device which sets a spatial relationship between the substrate and the suction device according to embodiments of the herein disclosed subject matter.

Unless otherwise specified, herein disclosed numerical values are to be understood to include a ±5% window, i.e., for example, a specification of a distance of 10 cm comprises, according to an embodiment, a distance within an interval of (10±5%) cm=[9.5 cm; 10.5 cm] and a percentage specification of 50% comprises, according to an embodiment, a percentage specification within an interval of 50%±5%=[47.5%; 52.5%]. According to a further embodiment, numerical values are to be understood to include a ±10% window.

In the following, exemplary embodiments of the herein disclosed subject matter are described, wherein for example reference is made to a suction device and a laser device. It should be emphasized that of course any combination of features of different aspects, embodiments and examples is possible. In particular, some embodiments are described with respect to a method, while other embodiments are described with respect to a device. Again, other embodiments are described with respect to a laser device, while other embodiments are described with respect to a control device for interacting with elements of the laser device. However, a person skilled in the art will learn from the above and the following description, claims and drawings that, unless otherwise specified, features of different aspects, embodiments and examples are combinable and such combinations of features are to be considered as disclosed by this application. For example, even a feature relating to a method is combinable with a feature relating to a device, and vice versa.

According to an embodiment, a method disclosed herein may define the functionality of a device disclosed herein without being limited to the device specific features. In this regard, any functionality disclosed herein of a device disclosed herein is intended to implicitly disclose a corresponding method defined solely by the disclosed functionality. Conversely, according to an embodiment, a method disclosed herein may be carried out with any suitable known device (which may comprise a single element or a plurality of cooperating elements). In this regard, any method disclosed herein is intended to implicitly disclose a corresponding device configured to carry out the method.

Other advantages and features of the present disclosure will become apparent from the following exemplary description of presently preferred embodiments, to which the claimed invention is not limited. The individual figures of the drawings of this document are to be regarded merely as schematic and not to scale.

### BRIEF DESCRIPTION OF THE DRAWINGS

FIG. 1 shows a suction device according to embodiments of the herein disclosed subject matter.

FIG. 2 shows the suction device of FIG. 1 without the imaginary sphere and the corresponding projections.

FIG. 3 shows a top view of the suction device of FIG. 2 as seen from line III-III.

FIG. 4 shows a perspective view of a further suction device according to embodiments of the herein disclosed subject matter.

FIG. 5 shows a part of a laser device according to embodiments of the herein disclosed subject matter.

FIG. 6 shows the laser device of FIG. 5 in a perspective view.

FIG. 7 shows a side view of a laser device according to embodiments of the herein disclosed subject matter.

### DETAILED DESCRIPTION

It should be noted that in different figures, similar or identical elements or components are provided with the same reference numerals, or with reference numerals which differ only in the first digit. Such features or components which are identical or at least functionally identical with the corresponding features or components in another figure are described in detail in the following text merely upon their first occurrence and the description is not repeated upon subsequent occurrence of these features and components (or the corresponding reference numerals).

It is understood that an exemplary implementation of the elements described below and provided with reference numerals is illustrated in the relevant drawings and configured according to the following description, unless expressly stated otherwise.

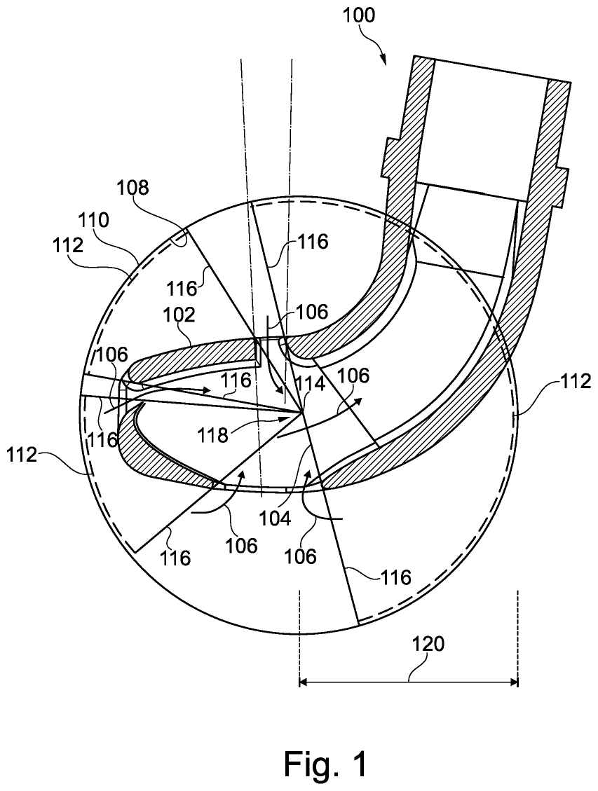

FIG. 1 shows a suction device 100 according to embodiments of the herein disclosed subject matter.

According to an embodiment, the suction device 100 comprises an air guiding device 102, as well as a flow inlet 104 for generating a suction flow 106 through the air guiding device 102 into the flow inlet 104. According to an embodiment, the air guiding device 102 is configured such that a projection of the air guiding device 102 onto a surface 108 of an imaginary sphere 110 covers at least 60% of the surface 108. In FIG. 1, the covering of the surface 108 of the sphere by the projection of the air guiding device is illustrated by dashed lines at 112, wherein for simplification only a sectional view of the sphere, its center point and three openings are shown. According to an embodiment, the projection of the air guiding device 102 onto the surface 108 covers at least 65% of the surface 108 or, according to a further embodiment, at least 70% of the surface 108, at least 80% of the surface 108 or at least 90% of the surface 108, for example as illustrated in FIG. 1.

The projection of the air guiding device 102 onto the surface 108 of the imaginary sphere 110 is within the scope of the present disclosure generally from a center point 114 of the imaginary sphere to the surface 108 of the imaginary sphere 110. Exemplary projection lines are illustrated in FIG. 1 at 116.

According to an embodiment, the center point 114 of the imaginary sphere 110 is arranged in a center 118 of the flow inlet 104. In other words, the imaginary sphere is arranged such that the center point 114 is located in the center 118 of the flow inlet 104. A radius 120 of the imaginary sphere 110 is according to an embodiment selected such that the imaginary sphere 110 completely encloses the air guiding device 102, for example as illustrated in FIG. 1.

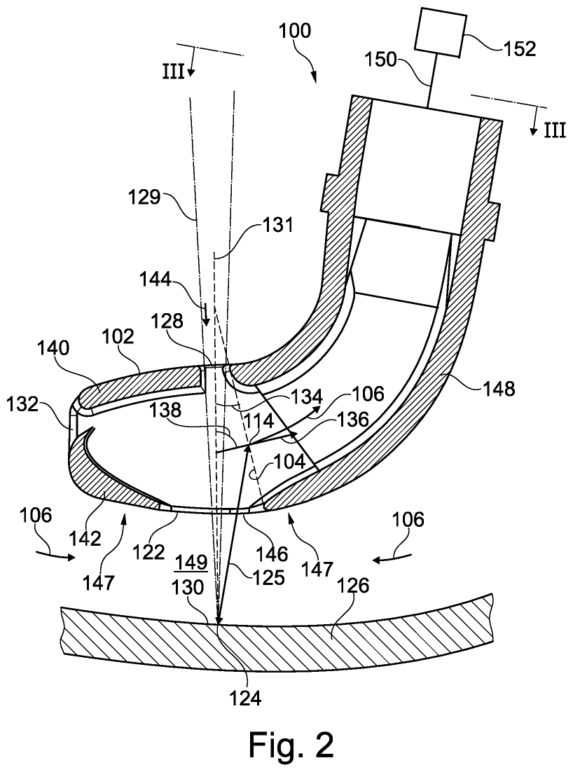

FIG. 2 shows the suction device 100 of FIG. 1 without the imaginary sphere and the corresponding projections in order to facilitate the identification of the individual elements of the suction device 100.

According to an embodiment, the air guiding device 102 comprises a first opening 122 which, in operation of the suction device 102, faces an irradiation region 124 on the substrate 126. According to a further embodiment, the air guiding device further comprises a second opening 128 which is arranged such that a laser radiation 129 can be emitted through the second opening 128 and the first opening 122 onto the substrate 126 or, respectively, a substrate surface 130 to be processed. According to an embodiment, the first opening 122 and the second opening 128 define (or, respectively, allow) a straight beam path 131 for the laser radiation 129 through the air guiding device 102.

According to an embodiment, a distance 125 of the center 114 of the flow inlet 104 (corresponding to the center point of the imaginary sphere, not illustrated in FIG. 2) from the irradiation region 124 is less than 20 cm.

According to an embodiment, the air guiding device comprises a third opening 132 which is arranged between the first opening 122 and the second opening 128, for example as illustrated in FIG. 2. According to an embodiment, the third opening 132 faces the flow inlet 104.

According to an embodiment, the flow inlet 104 is arranged at an acute angle 134 with respect to the beam path 131, wherein the acute angle is between 1 degree and 50 degrees, for example 13 degrees, for example as illustrated in FIG. 2. According to a further embodiment, the suction flow 106 in the flow inlet 104 has a flow direction 136, wherein the beam path 131 forms an angle 138 with the flow direction 136 which is greater than 30 degrees, for example as illustrated in FIG. 2. According to an embodiment, the flow direction 136 of the suction flow 106 in the flow inlet 104 is perpendicular or almost perpendicular to a plane in which the flow inlet extends, for example as illustrated in FIG. 2.

According to an embodiment, the air guiding device comprises at least two sections, for example a first section 140 and a second section 142, which are spatially fixed relative to each other. According to an embodiment, the suction flow 106 comprises a flow part 144 of which at least one directional component extends along the straight beam path 131 through the second opening 128 into the air guiding device 102, for example as illustrated in FIG. 2.

According to an embodiment, an edge 146 of the suction device 100 has a radius of curvature (transverse to a longitudinal direction of the edge) which is greater than 0.5 millimeters, for example as illustrated in FIG. 2. According to an embodiment, the edge 146 in its longitudinal direction may follow at least in one section a curvature of the substrate surface 130 or may be approximated to the curvature of the substrate surface 130, for example as illustrated in FIG. 2. For example, for the case that the substrate 126 is a pneumatic tire, the surface 130 of which to be processed has a certain curvature, it may be advantageous for good suction if a part 147 of the suction device 100 (also referred to herein as a foot part) opposite the substrate surface 130 has a similar curvature as the substrate surface 130 or is curved at least in the same direction as the substrate surface 130.

According to an embodiment, the foot part 147 together with the substrate surface 130 facing it defines a second flow path 149 for the suction flow 106 which flows into the air guiding device 102 through the first opening 122.

According to an embodiment, the flow inlet 104 is formed by an end of a pipe section 148, for example as illustrated in FIG. 1. According to an embodiment, the pipe section 148 is part of a piping 150 which is illustrated partially merely schematically in FIG. 2 and which fluidically connects the flow inlet 104 to a negative pressure source 152 (for example a suction pump). In this way, the suction flow 106 can be generated in the flow inlet 104 by means of the negative pressure source 152.

According to an embodiment, the flow inlet 104 is defined by the pipe section 148 and a plane which touches both the first opening 122 and the second opening 128, for example as illustrated in FIG. 2.

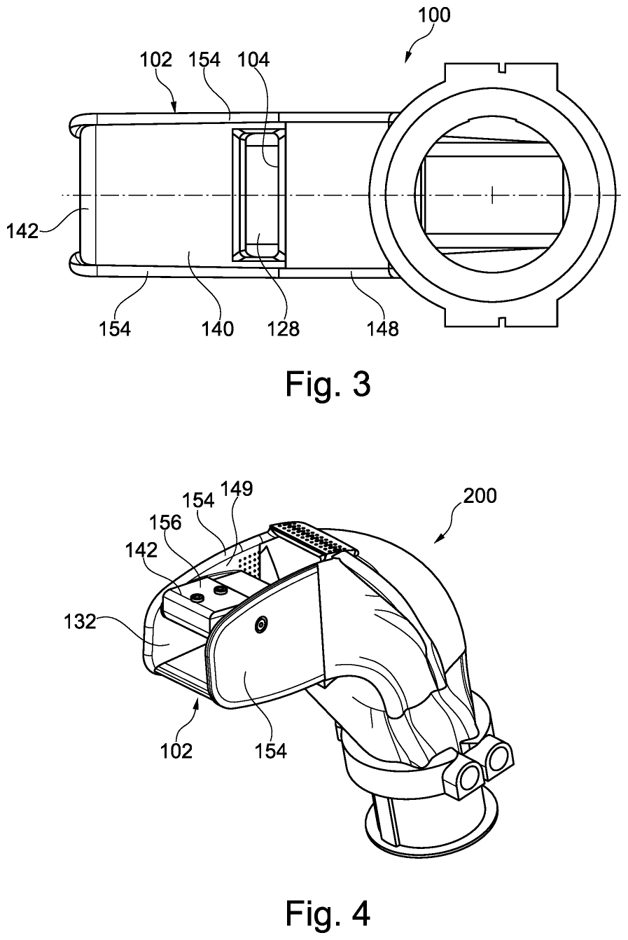

FIG. 3 shows a top view of the suction device 100 of FIG. 2 as seen from line III-III.

According to an embodiment, the air guiding device comprises two lateral sections 154 between which the first section 140 and the second section 142 of the air guiding device are arranged, for example as illustrated in FIG. 3. According to an embodiment, the first section 140 and the second section 142 are attached to the lateral sections 154. This can allow a structurally simple construction of the air guiding device.

According to an embodiment, the air guiding device is closed laterally next to the first opening 122 (not illustrated in FIG. 3) and the second opening 128. For example, the lateral sections 154 can be closed (i.e. formed without openings). According to an embodiment, the lateral sections 154 are formed plate-shaped, for example as illustrated in FIG. 3.

According to an embodiment, the pipe section 148 is rectangular in its outer shape in the region of the flow inlet 104. This can allow a simple mounting of the lateral sections 154 of the air guiding device 102 on the pipe section 148.

FIG. 4 shows a perspective view of a further suction device 200 according to embodiments of the herein disclosed subject matter.

Compared to the suction device 100 in FIGS. 1 to 3, the implementation of the suction device 200 in FIG. 4 according to an embodiment comprises an enlarged third opening 132. According to a further embodiment, a surface 156 of the second section 142 of the air guiding device opposite the substrate 126 (not illustrated in FIG. 4) does not follow the curvature of the lateral sections 154 of the air guiding device 102. The surface 156 of the second section 142 is also referred to herein as a foot surface of the suction device. According to an embodiment, the lateral sections 154 extend beyond the foot surface 156 of the air guiding device 102, for example as illustrated in FIG. 4, and thus define a second flow path 149 between the air guiding device 102 and the substrate 126 which is laterally limited by the lateral sections 154 of the air guiding device 102.

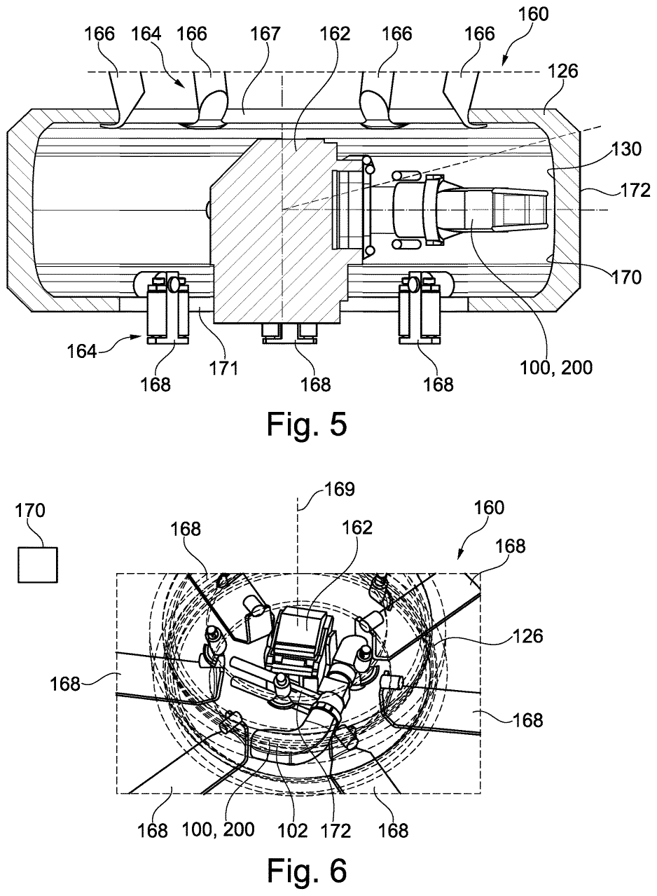

FIG. 5 shows a part of a laser device 160 according to embodiments of the herein disclosed subject matter.

According to an embodiment, the laser device 160 comprises a laser emitting device 162 for emitting laser radiation, as well as a suction device according to embodiments of the herein disclosed subject matter, for example a suction device 100, 200 as illustrated and described with respect to FIGS. 1 to 4.

According to an embodiment, the substrate 126 is a pneumatic tire, for example a pneumatic tire as illustrated in cross-section in FIG. 5. In the following, some embodiments are described with respect to a pneumatic tire 126, wherein it should be understood that the reference to a pneumatic tire is only exemplary here and the relevant embodiments are analogously applicable to any suitable substrate 126.

According to an embodiment, the laser device comprises a substrate carrier 164 which is configured for carrying the pneumatic tire 126 during the processing of the surface 130 of the pneumatic tire. According to an embodiment, the substrate carrier 164 comprises a number of first holding elements 166 which carry the pneumatic tire in the region of a first bead 167, as well as a number of second holding elements 168 which carry the pneumatic tire 126 in the region of a second bead 171. For example, eight first holding elements 166 and six second holding elements 168 can be provided. According to an embodiment, the first holding elements 166 and the second holding elements 168 are configured for maintaining the first bead 167 and the second bead 171 at a predetermined distance relative to each other. In this way, in an embodiment, a quality of the laser processing as well as a quality of the suction can be improved.

According to an embodiment, the laser emitting device 162 and the suction device 100, 200 are configured (or configurable) for processing an inner surface 170 facing away from a tread 172 of the pneumatic tire 126, for example as illustrated in FIG. 5.

FIG. 6 shows the laser device 160 of FIG. 5 in a perspective view.

According to an embodiment, the laser emitting device 162 and the suction device 100, 200 are configured for finding space radially within the pneumatic tire 126 and radially within the first and second holding elements 166, 168. According to an embodiment, the laser emitting device 162 and the suction device 100, 200 are arranged on a common carrier (not illustrated in FIG. 6). In this way, a position and/or an orientation of the laser emitting device 162 relative to the pneumatic tire 126 may be changed without changing the spatial relationship between the laser emitting device 162 and the suction device 100, 200. In other words, according to an embodiment, the laser emitting device 162 and the suction device 100, 200 are spatially fixed or fixable relative to each other. In this way, the laser radiation 129 (not illustrated in FIG. 6) is reliably emitted through the first opening 122 and the second opening 128 of the air guiding device 102.

According to an embodiment, the laser emitting device 162 is arranged in the center of the pneumatic tire 126 and is rotatable about a tire rotation axis 169 of the pneumatic tire 126, whereby the laser radiation 129 emitted by the laser emitting device is pivoted with respect to the surface 130 of the tire.

According to a further embodiment, the laser device comprises a control device 170 which is controllably connected to the laser emitting device 162 for controlling the laser emitting device 162 (the connection is not illustrated in FIG. 6 for reasons of clearness).

According to a further embodiment, the laser device 160 comprises an actuator arrangement 172 which is configured for moving the suction device 100, 200 (and thus in an embodiment also the air guiding device 102 and/or the flow inlet 104 (not illustrated in FIG. 6)) radially to the tire rotation axis 169. In this way, the air guiding device 102 can be positioned at a suitable distance to the surface 130 of the pneumatic tire to be processed. According to an embodiment, the actuator arrangement 172 is controlled by the control device 170.

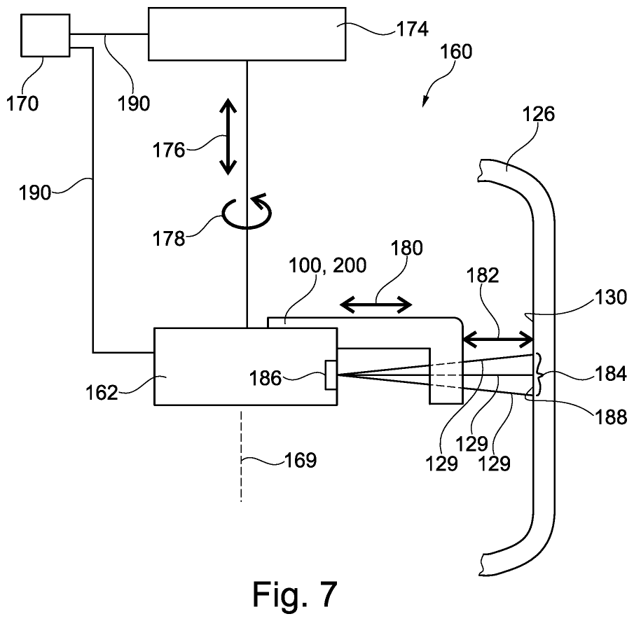

FIG. 7 shows a side view of a laser device 160 according to embodiments of the herein disclosed subject matter.

According to an embodiment, the laser device 160 comprises a further actuator arrangement 174 with which the laser emitting device 162 and the suction device 100, 200 are movable in axial direction (i.e. in direction parallel to the tire rotation axis 169), as specified in FIG. 7 at 176, for example for positioning the laser emitting device and the suction device 100, 200 within the pneumatic tire 126 for processing the pneumatic tire 126, for example as illustrated in FIG. 7. After the processing of the pneumatic tire is completed, according to an embodiment the laser emitting device 162 and the suction device 100, 200 are movable out of the pneumatic tire 126 in the axial direction 176, for example for transporting the pneumatic tire transversely to the tire rotation axis 169 (for example by means of a conveyor belt, not illustrated). According to an embodiment, the further actuator arrangement 174 is configured for rotating the laser emitting device 162 and the suction device 100, 200, specified at 178, for example about the tire rotation axis 169, and thereby pivoting the laser radiation 129 in circumferential direction of the tire.

As already explained with respect to FIG. 6, according to an embodiment, an actuator arrangement 172 can be provided (not illustrated in FIG. 7) by means of which the suction device 100, 200 is movable in radial direction (specified in FIG. 7 at 180) with respect to the tire rotation axis 169, for example with respect to the laser emitting device 162. In this way, a distance 182 between the suction device 100, 200 and the pneumatic tire 126 (or the substrate) can be adjustable.

According to a further embodiment, the laser emitting device 162 is configured for pivoting the laser radiation 129 with respect to the laser emitting device 162 and thereby pivoting the laser radiation 129 over an angular range 184, for example as illustrated in FIG. 7. The angular range 184 over which the laser radiation 129 is pivoted (without a movement of the laser emitting device 162 being required for this purpose) corresponds, on the surface 130 to be processed, to an irradiation region 188 within the meaning of the herein disclosed subject matter. For example by a rotation 178 and/or an axial movement 176, this irradiation region 188 can be moved over the surface 130 of the pneumatic tire 126 (and thus over the entire processing region to be processed by the laser radiation 129). Due to the pivoting over the angular range 184, the irradiation region 188 is larger than an area of a laser spot generated by the laser radiation 129.

According to an embodiment, the first opening 122 and the second opening 128 of the air guiding device 102 are dimensioned (see also FIG. 3) such that, during the pivoting of the laser radiation 129 over the angular range 184, the laser radiation 129 can pass unhindered through the first opening 122 and the second opening 128 of the air guiding device 102 (and thus through the air guiding device 102 as a whole). For example, at least one galvanometer scanner 186 can be provided for pivoting the laser radiation 129.

According to an embodiment, the further actuator arrangement 174 and the laser emitting device are controlled by the control device 170, as schematically specified at 190 in FIG. 7.

According to embodiments of the herein disclosed subject matter, any suitable entity (e.g. devices, elements or parts) can be provided at least partially in the form of corresponding computer programs which allow a processor device to provide the functionality of the corresponding entity as described herein. According to other embodiments, any suitable entity as described herein can be provided in hardware. According to other, hybrid embodiments, some entities can be provided in software while other entities are provided in hardware.

It is noted that any entity disclosed herein (e.g. a device, an arrangement, an elements, etc.) is not limited to a dedicated entity as described in some embodiments. Rather, the herein described subject matter can be provided in different ways with different granularity at device level or at function level while still providing the specified functionality. According to other embodiments, an entity can be configured to provide two or more functions as described herein. According to still other embodiments, two or more entities can be configured to together provide a function as described herein.

According to an embodiment, the control device includes a processor device which comprises at least one processor for executing at least one program element which can correspond to a corresponding software module.

A definition of an optical arrangement and/or an optical geometry with respect to a laser radiation can of course also be defined analogously with respect to a beam path of the laser radiation, and vice versa. In this regard, herein any reference to a laser radiation discloses analogously a reference to a beam path of the laser radiation.

It is pointed out that the embodiments described herein represent only a limited selection of possible embodiments of the present disclosure. Thus, it is possible to combine the features of different embodiments with each other in a suitable manner, so that for a person skilled in the art with the herein explicitly disclosed embodiments a plurality of combinations of different embodiments are to be considered as disclosed. Further, it should be mentioned that terms such as “a” or “an” do not exclude a plurality. Terms such as “comprising” or “having” do not exclude further features or method steps. Thus, according to an embodiment, the term “comprising” or “having” stands for “comprising, among other things”. According to a further embodiment, the term “comprising” or “having” stands for “consisting of”.

It should also be noted that reference numerals in the claims should not be construed as limiting the scope of the claims. Further, it should be noted that reference numerals in the description and the reference of the description to the drawings should not be construed as limiting the scope of the description. Rather, the drawings illustrate only one exemplary implementation of a particular combination of a plurality of embodiments of the herein disclosed subject matter, wherein any other combination of embodiments is equally possible and is to be considered as disclosed with this application.

In an exemplary implementation comprising an advantageous combination of herein disclosed embodiments, the following can be stated:

Disclosed is a suction device comprising: an air guiding device and a flow inlet for generating a suction flow through the air guiding device into the flow inlet. The air guiding device is configured is such that a projection of the air guiding device onto a surface of an imaginary sphere covers at least 30% of the surface. Herein, the projection is in a radial direction from a center point of the imaginary sphere to the surface of the imaginary sphere, wherein the center point of the imaginary sphere is arranged in a center of the flow inlet. A radius of the imaginary sphere is selected to be so large that the imaginary sphere completely encloses the air guiding device. The air guiding device comprises a first opening which, in operation, faces a processing location on a substrate and a second opening through which a laser radiation can be emitted through the air guiding device and through the first opening. Further disclosed is a laser device comprising the suction device and a laser emitting device.

1.-32. (canceled)

33. A suction device comprising:
an air guiding device;
a flow inlet for generating a suction flow through the air guiding device into the flow inlet;
wherein the air guiding device is configured such that a projection of the air guiding device onto a surface of an imaginary sphere covers at least 60% of the surface;
wherein the projection is in a radial direction from a center point of the imaginary sphere to the surface of the imaginary sphere;
wherein the center point of the imaginary sphere is arranged in a center of the flow inlet;
wherein a radius of the imaginary sphere is selected to be so large that the imaginary sphere completely encloses the air guiding device;
wherein the air guiding device further comprises a first opening which, in operation, faces a processing location on a substrate; and
wherein the air guiding device further comprises a second opening through which a laser radiation can be emitted through the air guiding device and through the first opening; and
wherein the substrate is a vulcanized rubber material.

34. The suction device according to claim 33,
wherein the air guiding device comprises a straight beam path for the laser radiation;
wherein the straight beam path extends through the second opening and the first opening.

35. The suction device according to claim 33, further comprising one of the following features:
the air guiding device comprises a third opening which is arranged between the first opening and the second opening;
the suction flow in the flow inlet has a flow direction and the straight beam path forms an angle with the flow direction which is greater than 30 degrees.

36. The suction device according to claim 35, further comprising one of the following features:
a sum of a cross-sectional area of the first opening, a cross-sectional area of the second opening and a cross-sectional area of the third opening is less than three times a cross-sectional area of the flow inlet;
a sum of a cross-sectional area of the first opening, a cross-sectional area of the second opening and a cross-sectional area of the third opening is less than two times a cross-sectional area of the flow inlet.

37. The suction device according to claim 33, further comprising one or more of the following features:
the projection of the air guiding device and a projection of the first opening together cover at least 70% of the surface of the imaginary sphere;
a window is arranged in the second opening;
the air guiding device comprises at least two sections which are spatially fixed relative to each other;
the radius of the imaginary sphere is a minimum radius with which the imaginary sphere completely encloses the air guiding device;
the air guiding device is mechanically connected to the flow inlet.

38. The suction device according to claim 33, wherein the air guiding device comprises a body and a coating on the body, wherein an adhesion of dirt particles to a material of which the coating is formed is reduced compared to an adhesion of the dirt particles to the material of the body.

39. The suction device according to claim 33,
wherein the projection of the air guiding device does not cover a surface portion of the surface of the imaginary sphere, which uncovered surface portion is arranged opposite to the flow inlet.

40. The suction device according to claim 34, wherein the suction flow through the air guiding device comprises a flow part of which at least one directional component extends along the straight beam path and in a direction through the second opening into the air guiding device.

41. The suction device according to claim 33, further comprising at least one of the following features:
a flow velocity in the flow inlet is at least 15 m/s; a volume flow in the flow inlet is more than 100 m³/h;
a cross-sectional area of the flow inlet is between 10 cm² and 30 cm²;
the flow inlet has a circular cross-section;
the first opening has a rectangular cross-section;
the first opening has a short side less than 20 mm.

42. The suction device according to claim 33, further comprising
a negative pressure source; and
a first flow path connecting the negative pressure source and the flow inlet for generating with the negative pressure source the suction flow into the flow inlet.

43. A laser device comprising:
a laser emitting device for emitting laser radiation to a substrate surface of a substrate and thereby processing the substrate surface in an irradiation region, wherein the substrate is a vulcanized rubber material;
a suction device for sucking off process residues arising in the processing of the substrate surface;
the suction device comprising:
an air guiding device;
a flow inlet for generating a suction flow through the air guiding device into the flow inlet;
wherein the air guiding device is configured such that a projection of the air guiding device onto a surface of an imaginary sphere covers at least 60% of the surface;
wherein the projection is in a radial direction from a center point of the imaginary sphere to the surface of the imaginary sphere;
wherein the center point of the imaginary sphere is arranged in a center of the flow inlet;
wherein a radius of the imaginary sphere is selected to be so large that the imaginary sphere completely encloses the air guiding device;
wherein the air guiding device further comprises a first opening which, in operation, faces a processing location on a substrate; and
wherein the air guiding device further comprises a second opening through which a laser radiation can be emitted through the air guiding device and through the first opening.

44. The laser device according to claim 43, further comprising at least one of the following:
an actuator arrangement for moving the irradiation region and the substrate surface relative to each other;
a substrate carrier, wherein the substrate carrier is configured for carrying the substrate during the processing of the substrate surface.

45. The laser device according to claim 43, further comprising at least one of the following features:
the center point of the imaginary sphere is less than 20 cm away from the irradiation region;
a second flow path is formed between the substrate and the air guiding device;
the second flow path has at its narrowest location a cross-sectional area whose area is larger than 5% of the area of the surface of the imaginary sphere;
the substrate is a pneumatic tire;
the laser device is configured for selectively removing rubber material;
the laser device is configured for removing process residues from the tire vulcanization;
at least one edge of the first opening has a radius of curvature which is greater than 0.5 mm;
at least one edge of the air guiding device has a radius of curvature which is greater than 0.5 mm;
the laser emitting device is configured for pivoting the laser radiation with respect to the substrate surface.

46. The laser device according to claim 45, further comprising one or more of the following features:
the second flow path has at its narrowest location a cross-sectional area whose area is smaller than 15% of the area of the surface of the imaginary sphere;
the second flow path guides at least a part of the suction flow over the irradiation region;
the substrate is an inner surface or a bead ring region of a pneumatic tire;
the laser device is configured for selectively removing rubber material for correcting concentricity properties of a pneumatic tire;
the laser device is configured for removing process residues from the tire vulcanization for removing a release agent remaining on a tire inner surface after the tire vulcanization.

47. The laser device according to claim 44, wherein a relative movement of the substrate surface and the irradiation region relative to each other is a circular movement about a tire rotation axis of the pneumatic tire.

48. The laser device according to claim 47, wherein the actuator arrangement is configured for moving the flow inlet radially to the tire rotation axis.

49. The laser device according to claim 43, further comprising a control device for controlling the laser emitting device.

50. The laser device according to claim 43, further comprising a control device which is configured for controlling the actuator arrangement.

51. The laser device according to claim 49, further comprising a further control device which is configured for controlling the actuator arrangement;
wherein the control device and the further control device are formed by a single, common control device.

52. A suction device for sucking off process residues arising in the processing of the substrate surface, the suction device comprising:
an air guiding device;
a flow inlet for generating a suction flow through the air guiding device into the flow inlet;
wherein the air guiding device is configured such that a projection of the air guiding device onto a surface of an imaginary sphere covers at least 60% of the surface;
wherein the projection is in a radial direction from a center point of the imaginary sphere to the surface of the imaginary sphere;
wherein the center point of the imaginary sphere is arranged in a center of the flow inlet;
wherein a radius of the imaginary sphere is selected to be so large that the imaginary sphere completely encloses the air guiding device;
wherein the air guiding device further comprises a first opening which, in operation, faces a processing location on a substrate; and
wherein the air guiding device further comprises a second opening through which a laser radiation can be emitted through the air guiding device and through the first opening.
